(19) United States
(12) Patent Application Publication
(10) Pub. No.: US 2002/0142098 A1
(43) Pub. Date: Oct. 3, 2002

(54) Method for finishing PVC/wood composite

(76) Inventor: Hossein Amin-Javaheri, Houston, TX (US)

Correspondence Address: Attn: James H. Riley II, SHOOK, HARDY & BACON L.L.P., Suite 1600, 600 Travis Street, Houston, TX, 77002-2911, US

(21) Appl. No.: 09/775,123

(22) Filed: Feb. 1, 2001

(51) Int. Cl. B05D 3/02; B05D 1/36

(52) U.S. Cl. 427/385.5; 427/407.1

(57) ABSTRACT

Methods for painting or staining articles made from PVC/wood composite, especially window blind slats. In one method of the present invention, the PVC/wood composite article is painted by applying a base coat of a hydrocarbon-based paint, at least partially drying the base coat, applying a top coat of a hydrocarbon-based paint, and drying the top coat. The base coat improves the adhesion of the top coat to the PVC/wood composite. In another embodiment, the article made from PVC/wood composite is stained by first applying a hydrocarbon-based stain, removing the excess stain, and allowing the stain to dry. Finally, a hydrocarbon-based clear lacquer is applied over the stained article and allowed to dry.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention relates to methods of finishing articles made from PVC/wood composite. More specifically, the present invention is directed at methods of painting or staining PVC/wood composite window blind slats using a sequential application of paints or stains to offer a more decorative look to PVC/wood composite window blinds. These methods eliminate the present requirement to overlay the PVC/wood composite with PVC in a co-extrusion process. This overlay is needed to mask the brownish color that results from using current PVC/wood composite in the manufacture PVC products, specifically window blinds.

2. Description of the Related Art

PVC/wood composite compounds are used to manufacture a variety of everyday household products. The advantage that PVC/wood composite has over ordinary PVC is that the finished product looks and feels more like real wood than plastic. The most common way to manufacture such PVC/wood composite products is by the extrusion process. However, upon initial processing, these PVC/wood composites produce a material that is brownish in color. Because this brown color is usually not desired, especially in decorative items such as window blinds, a second manufacturing step is required in which the PVC/wood composite is covered with a thin layer of PVC in a co-extrusion process to give the desired color, usually white.

The present invention allows for the painting or staining of PVC/wood composite window blind slats in order to achieve a desired color or appearance. The present invention allows for the masking of the brown color of the PVC/wood composite without having to layer the PVC/wood composite material with a layer of PVC. There are significant economic disadvantages, such as higher labor, material and manufacturing costs, that result from having to cover the brownish colored PVC/wood composite with a PVC coating. Furthermore, the PVC coating makes the finished product feel more like plastic than wood.

These Methods of painting and staining window blinds made of PVC/wood composites offer distinct advantages over existing PVC/wood composite finishing methods. Furthermore, these methods overcome the adherence problem normally associated with painting PVC-based materials.

### SUMMARY OF THE INVENTION

The primary object of this invention is to provide efficient, quick and inexpensive methods of painting or staining articles made from PVC/wood composite, specifically window blind slats. The invention allows for the painting or staining of PVC/wood composite window blind slats by introducing an economical and efficient method in which paint or stain will adhere to this PVC-based product.

One embodiment of the present invention comprises a novel method for painting PVC/wood composite window blind slats by applying a base coat of a hydrocarbon-based paint, which is preferably a clear lacquer, to the PVC/wood composite window blind slat and the subsequent application of a top coat of a hydrocarbon-based paint in the desired color. The present invention also comprises a novel method for staining PVC/wood composite window blind slats comprising the application of a hydrocarbon-based stain having the desired tint, followed by the application of a hydrocarbon-based clear lacquer as a top coat.

### BRIEF DESCRIPTION OF THE DRAWINGS

Not applicable.

### DETAILED DESCRIPTION OF INVENTION

The present invention provides an improved, more efficient, and cost effective method for painting and staining PVC/wood composite window blinds. PVC/wood compositions are well suited for the manufacture of window blinds and other similar products because the addition of wood powder changes the texture of the PVC so it looks and feels more like real wood. Additionally, window slats made of PVC/wood composite material are substantially cheaper than slats made from real wood.

The disadvantage associated with this wood formulation of PVC is that the wood powder imparts a brownish color to the PVC. Some manufacturers use the PVC/wood composite by itself to make a brownish colored slat for use in window blinds. The wood colored slat can be embossed with a wood grain to make it more aesthetically pleasing. More often however, the brownish material is extruded as a substrate for further processing because wood colored slats are not that popular. In a second step, the manufacturer puts a thin PVC layer over the entire substrate. Most often, this PVC layer is co-extruded with the PVC/wood composite as described in U.S. Pat. No. 6,083,601. Efforts to paint or stain the PVC/wood composite have been unsuccessful because ordinarily paint or stain will not adhere well to the PVC/wood composite. The present invention solves the adhesion problem and permits the coloring or staining of the PVC/wood composite material.

This invention pertains to methods of painting and staining PVC/wood composite window blinds. The preferred painting method uses a base coat having a hydrocarbon-based solvent. This base coat is dried, and a hydrocarbon-based top coat is applied in a similar manner. The top coat contains pigment of the desired color, and the entire slat is allowed to dry. In the most preferred embodiment, the slat is lightly buffed or “denibbed,” prior to the application of top coat to improve the adhesion and texture of the top coat.

Because of the physical nature of window slats, it is preferred to divide each of these process steps into two distinct steps. For example, in the preferred method, the slat is fed through a painting station wherein a flow coater applies the base coat onto one broad side of the slat and at least part of the adjacent thin sides. The coating is allowed to dry, preferably in a drying oven, to evaporate the solvent. Under normal conditions, this drying process takes about 10 minutes. Next, the slat is turned over so the process can be repeated to cover the underside of the slat. The slat is allowed to throughly dry, usually for about 60 to 100 minutes, before further processing. After the base-coat has throughly dried, the slat is preferably buffed to smooth out the imperfections and to improve adhesion of the top coat. Of course, the buffing step can be performed on each side after that side is dried, but preferably it is performed after both sides have been painted and dried. Finally, the top coat is applied in substantially the same manner as the base coat. The top coat dries under the same conditions as the base coat with the first side drying in about 10 minutes in a drying oven. After the second side is painted, the finished product is allowed to thoroughly dry. Normally, the top coat is fully cured in about 60 to about 100 minutes.

For the purposes of this invention, the following formulas represent the preferred embodiments for the base coat and the top coat.

% by Weight

BASE COAT

| | |
|---|---|
| Calcium Carbonate | 15-25% |
| Methyl Ethyl Ketone (MEK) | 15% |
| Titanium Dioxide | 10-15% |
| VM & P Naphtha | 5-10% |
| Isopropanol | 5-10% |
| Nitrocellulose | 5-10% |
| Toluene (Methyl Benzene) | 5% |
| Ethyl Acetate | 1-5% |
| #2 Butoxyethanol | 4% |
| Butyl Acetate | 1-5% |
| Diisononyl Phthalate | 1-5% |
| Aliphatic Solvent | 1-5% |
| Heptane | 1-5% |
| Ethyl Benzene | 0.5% |

TOP COAT

| | |
|---|---|
| Butyl Acetate | 10-15% |
| Titanium Dioxide | 10-15% |
| Methyl Isobutyl Ketone | 13.2% |
| Isopropanol | 10-15% |
| Methyl Ethyl Ketone | 11.8% |
| Nitrocellulose | 5-10% |
| Diisononyl Phthalate | 5-10% |
| Ethyl Acetate | 1-5% |
| Aliphatic Solvent | 1-5% |
| Toluene | 2.1% |
| Isobutanol | 1-5% |
| Ethyl Benzene | 0.7% |

The staining method is an alternate embodiment, and the preferred embodiment comprises the following steps: a hydrocarbon-based stain containing tints in the desired color is applied to the slat with a compressed air spray gun. Normally, there is excess stain on the surface of the slat. This excess stain should be wiped off to create a uniform coloration. A cotton fabric is well suited to remove the excess stain. Next, the base stain is air dried for about 30 minutes, and the process is repeated on the opposite side. Preferably, the stained slat is buffed to improve its feel. Finally, a hydrocarbon-based clear lacquer is applied to the slat, preferably with a flow coater, in a manner similar to the painted embodiment. The slat is oven dried for about 15 to 20 minutes, and the process is repeated on the opposite side of the slat. After the second side is coated, the finished product is allowed to thoroughly dry. Normally, the clear coat is fully cured in about 60 to about 100 minutes.

The following formulas represent the preferred embodiments for the stain and the clear coat. Of course, the tint in the stain can be varied to create a variety of shades.

% by Weight

STAIN

| | |
|---|---|
| BASE | |
| Methyl Ethyl Ketone (MEK) | 39% |
| Lactol Spirits | 10% |
| Toluene (Methyl Benzene) | 7-10% |
| VM & P Naphtha | 7% |
| Isopropanol | 5-10% |
| Butyl Acetate | 4% |
| Acetone | 3% |
| Methyl Isobutyl Ketone | 1-5% |
| Isobutyl Alcohol | 3% |
| Xylene | 2% |
| TINT | |
| Yellow Iron Dioxide | 10-15% |
| Red Oxide | 1-3% |
| Burnt Umber | 0.5% |

CLEAR COAT

| | |
|---|---|
| N-Butyl Acetate | 30-35% |
| VMP Naphtha | 20-25% |
| Methyl Benzene Toluene | 10-15% |
| Isopropanol | 10-15% |
| Methyl Ethyl Ketone | 5-10% |
| Nitrocellulose | 5-10% |
| Dioctylphthalate | 2% |
| 2-Butoxyethanol | 2% |
| Isobutanol | 1% |

In accordance with this invention, articles made from PVC/wood composite, especially window blind slats, can be efficiently and economically finished to have whatever color or tint desired.

I claim:

1. A method for finishing articles made from PVC/wood composite comprising the steps of:
applying a base coat of hydrocarbon-based paint to the PVC/wood composite;
allowing the base coat to dry on the article;
applying a top coat of hydrocarbon-based paint to the article; and,
allowing the top coat to dry to create the finished article.

2. The method of claim 1 wherein the article is a window blind slat.

3. The method of claim 2 wherein the first drying step is performed in an oven for about 10 minutes.

4. The method of claim 2 wherein the second drying step is performed in the air for about 60 to about 100 minutes.

5. The method of claim 2 wherein the top coat is pigmented to impart a particular color.

6. The method of claim 2 wherein the base coat is applied in two steps.

7. The method of claim 6 further comprising applying the base coat to one side of the slat in a first pass, allowing the base coat to dry, applying the base coat to the other side of the slat in a second pass, and allowing the base coat to dry.

8. The method of claim 7 further comprising using a flow coater to apply the base coat.

9. The method of claim 2 wherein the top coat is applied in two steps.

10. The method of claim 9 further comprising applying the top coat to one side of the slat in a first pass, allowing the top coat to dry, applying the top coat to the other side of the slat in a second pass, and allowing the top coat to dry.

11. The method of claim 10 further comprising using a flow coater to apply the top coat.

12. The method of claim 2 wherein both the base coat and the top coat are applied in two steps.

13. The method of claim 12 further comprising:
applying the base coat to one side of the slat in a first pass, allowing the base coat to dry, applying the base coat to the other side of the slat in a second pass, and allowing the base coat to dry; and,
applying the top coat to one side of the slat in a first pass, allowing the top coat to dry, applying the top coat to the other side of the slat in a second pass, and allowing the top coat to dry.

14. The method of claim 13 further comprising using a flow coater to apply the base coat and the top coat.

15. A method for finishing a window blind slat made from PVC/wood composite comprising the steps of:
applying a base coat of hydrocarbon-based paint to one side of the slat in a first pass;
allowing the base coat to dry on the slat;
applying the base coat to the other side of the slat in a second pass;
allowing the base coat to dry on the slat;
buffing the slat having the dried base coat;
applying a top coat to one side of the coated slat in a first pass;
allowing the top coat to dry on the slat;
applying the top coat to the other side of the coated slat in a second pass;
allowing the top coat to dry on the slat.

16. The method of claim 15 further comprising using a flow coater to apply the base coat and the top coat.

17. The method of claim 15 wherein the base coat is dried in an oven for about 10 minutes.

18. The method of claim 15 wherein the top coat is dried in the air for about 60 to about 100 minutes.

19. A method for finishing articles made from PVC/wood composite comprising the steps of:
applying a hydrocarbon-based stain to the PVC/wood composite;
removing the excess stain from the article;
allowing the stain to dry on the article;
applying a clear coat of hydrocarbon-based laquer to the article; and,
allowing the clear coat to dry to create the finished article.

20. The method of claim 19 wherein the article is a window blind slat.

21. The method of claim 20 wherein the first drying step is performed in air for about 30 minutes.

22. The method of claim 20 wherein the second drying step is performed in the air for about 60 to about 100 minutes.

23. The method of claim 20 wherein the stain is tinted to impart a particular shade.

24. The method of claim 20 wherein the stain is applied in two steps.

25. The method of claim 24 further comprising applying the stain to one side of the slat in a first pass, removing the excess stain, allowing the stain to dry on the slat, applying the stain to the other side of the slat in a second pass, removing the excess stain, and allowing the stain to dry on the slat.

26. The method of claim 25 further comprising using a compressed air spray gun to apply the stain.

27. The method of claim 20 wherein the clear coat is applied in two steps.

28. The method of claim 27 further comprising applying the clear coat to one side of the slat in a first pass, allowing the top coat to dry on the slat, applying the clear coat to the other side of the slat in a second pass, and allowing the clear coat to dry on the slat.

29. The method of claim 28 further comprising using a flow coater to apply the top coat.

30. The method of claim 20 wherein both the stain and the clear coat are applied in two steps.

31. The method of claim 30 further comprising:
applying the stain to one side of the slat in a first pass, removing the excess stain from the slat, allowing the stain to dry on the slat, applying the stain to the other side of the slat in a second pass, removing the excess stain from the slat, and allowing the stain to dry on the slat; and,
applying the clear coat to one side of the slat in a first pass, allowing the clear coat to dry on the slat, applying the clear coat to the other side of the slat in a second pass, and allowing the clear coat to dry on the slat.

32. The method of claim 31 further comprising using a compressed air gun to apply the stain and a flow coater to apply the clear coat.

33. A method for finishing a window blind slat made from PVC/wood composite comprising the steps of:
applying a hydrocarbon-based stain to one side of the slat in a first pass;
removing the excess stain from the slat;
allowing the stain to dry on the slat;
applying the stain to the other side of the slat in a second pass;
removing the excess stain from the slat;
allowing the stain to dry on the slat;
buffing the slat having the dried stain;
applying a hydrocarbon-based clear coat to one side of the stained slat in a first pass;
allowing the clear coat to dry on the slat;
applying the clear coat to the other side of the stained slat in a second pass;
allowing the clear coat to dry on the slat.

34. The method of claim 33 further comprising using a compressed air gun to apply the stain and a flow coater to apply the clear coat.

35. The method of claim 33 wherein the stain is dried in the air for about 30 minutes.

36. The method of claim 33 wherein the clear coat is dried in the air for about 60 to about 100 minutes.
